(19) United States
(12) Patent Application Publication
(10) Pub. No.: US 2005/0214493 A1
(43) Pub. Date: Sep. 29, 2005

(54) Refractory building structure formed by regeneration product made of waste material

(76) Inventor: Cheng-Chung Yu, Xinzhu Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/813,512

(22) Filed: Mar. 29, 2004

(51) Int. Cl. B32B 1/08

(52) U.S. Cl. 428/36.91

(57) ABSTRACT

A refractory building structure includes a regeneration layer, and at least one non-metallic fiber layer mounted in the regeneration layer. The regeneration layer is coated on an outside of the non-metallic fiber layer and includes cement, mineral waste and adhesive. Thus, the refractory building structure efficiently reuses the waste material, thereby recycling the natural resources, and thereby reducing the environmental pollution.

### BACKGROUND OF THE INVENTION

1. Field of the Invention

The present invention relates to a refractory building structure formed by a regeneration product made of waste material, and more particularly to a refractory building structure that efficiently reuses the waste material, thereby recycling the natural resources, and thereby reducing the environmental pollution.

2. Description of the Related Art

In general, the mineral wastes such as coal ashes, coal cinder, slag, incinerated cinder, mud ashes, reaction ashes, dust ashes, waste porcelain clay and waste casting sand are largely produced in the modern world. However, the mineral wastes are not reused and recycled, thereby causing consumption of the natural resources, and thereby increasing the environmental pollution.

### SUMMARY OF THE INVENTION

The primary objective of the present invention is to provide a refractory building structure formed by a regeneration product made of waste material.

Another objective of the present invention is to provide a refractory building structure that efficiently reuses the waste material, thereby recycling the natural resources, and thereby reducing the environmental pollution.

A further objective of the present invention is to provide a refractory building structure that contains a non-metallic fiber layer so as to enhance the stiffness of the refractory building structure.

In accordance with the present invention, there is provided a refractory building structure, comprising:
a regeneration layer; and
at least one non-metallic fiber layer mounted in the regeneration layer; wherein:
the regeneration layer is coated on an outside of the non-metallic fiber layer;
the regeneration layer includes cement, mineral waste and adhesive.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a refractory building structure in accordance with the preferred embodiment of the present invention;

FIG. 2 is a perspective view of a refractory building structure in accordance with another embodiment of the present invention;

FIG. 3 is a perspective view of a refractory building structure in accordance with another embodiment of the present invention; and

FIG. 4 is a perspective view of a refractory building structure in accordance with another embodiment of the present invention.

### DETAILED DESCRIPTION OF THE INVENTION

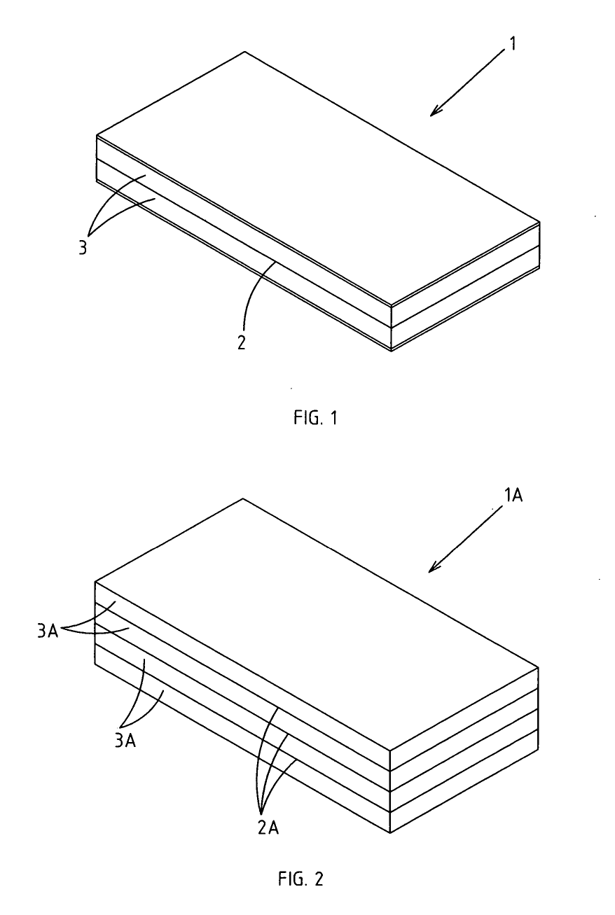

Referring to the drawings and initially to FIG. 1, a refractory building structure 1 in accordance with the preferred embodiment of the present invention comprises a regeneration layer 3, and at least one non-metallic fiber layer 2 mounted in the regeneration layer 3. Preferably, the regeneration layer 3 is coated on an outside of the non-metallic fiber layer 2. In addition, the regeneration layer 3 is combined with the non-metallic fiber layer 2 to form a sheet plate.

In practice, the regeneration layer 3 includes cement, mineral waste, adhesive and chemical agent.

Preferably, the weight ratio of the cement contained in the regeneration layer 3 is about 35% to 45%.

The mineral waste includes coal ashes, coal cinder, slag, incinerated cinder, mud ashes, reaction ashes, dust ashes, waste porcelain clay and waste casting sand. The granules of the mineral waste are distributed in the regeneration layer 3 evenly and smoothly. Preferably, the weight ratio of the mineral waste contained in the regeneration layer 3 is about 35% to 45%.

The adhesive is preferably a hydrophilic adhesive, such as the white shellac resin or the like. Preferably, the weight ratio of the adhesive contained in the regeneration layer 3 is about 1% to 5%.

The chemical agent is preferably a dehydrating agent, plasticizer or strengthening additive so as to enhance the strength of the refractory building structure 1. Preferably, the weight ratio of the chemical agent contained in the regeneration layer 3 is about 1% to 5%.

The non-metallic fiber layer 2 is preferably a non-woven fabric so as to enhance the stiffness of the refractory building structure 1.

Accordingly, the refractory building structure efficiently reuses the waste material, thereby recycling the natural resources, and thereby reducing the environmental pollution.

As shown in FIG. 2, the refractory building structure 1A comprises a regeneration layer 3A, and a plurality of non-metallic fiber layers 2A mounted in the regeneration layer 3A and arranged in a parallel manner.

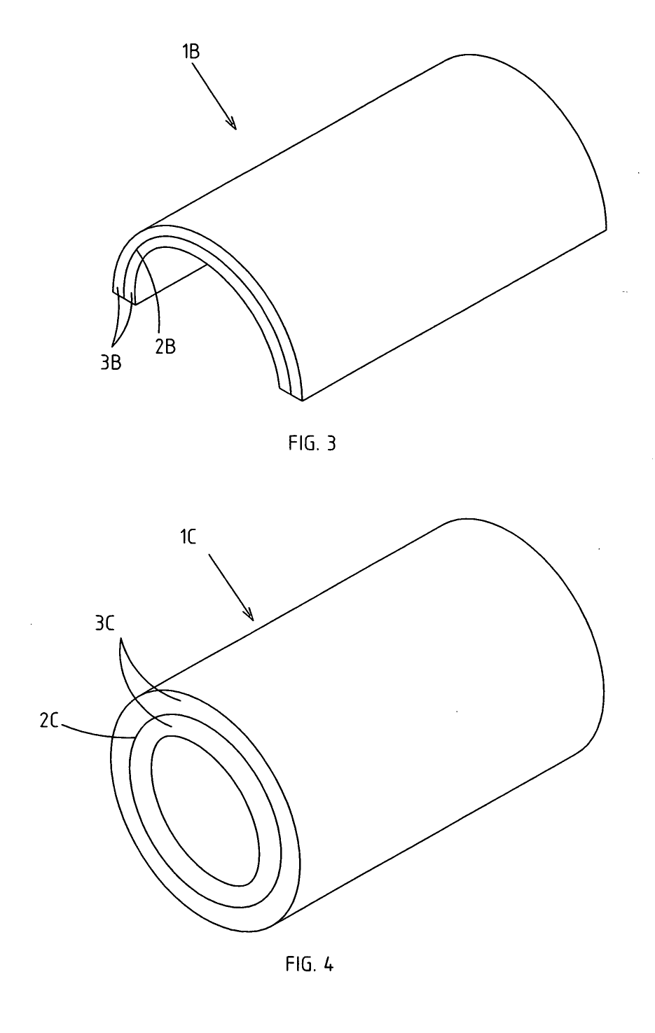

As shown in FIG. 3, the refractory building structure 1B comprises a regeneration layer 3B, and at least one non-metallic fiber layers 2B mounted in the regeneration layer 3B. In addition, the regeneration layer 3B is combined with the non-metallic fiber layer 2B to form a substantially semi-cylindrical plate.

As shown in FIG. 4, the refractory building structure 1C comprises a regeneration layer 3C, and at least one non-metallic fiber layers 2C mounted in the regeneration layer 3C. In addition, the regeneration layer 3C is combined with the non-metallic fiber layer 2C to form a substantially tubular structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A refractory building structure, comprising:
a regeneration layer; and
at least one non-metallic fiber layer mounted in the regeneration layer; wherein:
the regeneration layer is coated on an outside of the non-metallic fiber layer;
the regeneration layer includes cement, mineral waste and adhesive.

2. The refractory building structure in accordance with claim 1, wherein the mineral waste includes coal ashes, coal cinder, slag, incinerated cinder, mud ashes, reaction ashes, dust ashes, waste porcelain clay and waste casting sand.

3. The refractory building structure in accordance with claim 1, wherein the adhesive is a hydrophilic adhesive.

4. The refractory building structure in accordance with claim 1, wherein the adhesive is a white shellac resin.

5. The refractory building structure in accordance with claim 1, wherein the regeneration layer further includes a chemical agent.

6. The refractory building structure in accordance with claim 5, wherein the chemical agent is a dehydrating agent.

7. The refractory building structure in accordance with claim 5, wherein the chemical agent is a plasticizer.

8. The refractory building structure in accordance with claim 5, wherein the chemical agent is a strengthening additive.

9. The refractory building structure in accordance with claim 1, wherein the non-metallic fiber layer is a non-woven fabric.

10. The refractory building structure in accordance with claim 1, wherein the refractory building structure comprises a plurality of non-metallic fiber layers mounted in the regeneration layer.

11. The refractory building structure in accordance with claim 10, wherein the non-metallic fiber layers are arranged in a parallel manner.

12. The refractory building structure in accordance with claim 1, wherein the regeneration layer is combined with the non-metallic fiber layer to form a sheet plate.

13. The refractory building structure in accordance with claim 1, wherein the regeneration layer is combined with the non-metallic fiber layer to form a substantially semi-cylindrical plate.

14. The refractory building structure in accordance with claim 1, wherein the regeneration layer is combined with the non-metallic fiber layer to form a substantially tubular structure.
